(19) United States
(12) Patent Application Publication
(10) Pub. No.: US 2026/0084683 A1
(43) Pub. Date: Mar. 26, 2026

(54) HYBRID ELECTRIC VEHICLE AND METHOD OF CONTROLLING REGENERATIVE BRAKING THEREFOR

(71) Applicants: HYUNDAI MOTOR COMPANY, Seoul (KR); KIA CORPORATION, Seoul (KR)

(72) Inventors: Tae Jun Ahn, Hwaseong-si (KR); Jong Bum Oh, Hwaseong-si (KR)

(73) Assignees: HYUNDAI MOTOR COMPANY, Seoul (KR); KIA CORPORATION, Seoul (KR)

(21) Appl. No.: 19/069,850

(22) Filed: Mar. 4, 2025

(30) Foreign Application Priority Data
Sep. 26, 2024 (KR) 10-2024-0130938

(51) Int. Cl. B60W 20/14; B60W 50/00

(52) U.S. Cl. CPC B60W 20/14; B60W 50/0097; B60W 2510/0208; B60W 2510/0638; B60W 2510/244; B60W 2520/10; B60W 2710/083

(57) ABSTRACT

A hybrid electric vehicle capable of more efficient regenerative braking and a regenerative braking control method therefor are provided. A method for controlling regenerative braking of a hybrid electric vehicle may include: determining, when a braking request occurs, a state of an engine clutch configured to selectively connect a first motor directly connected to an engine and a second motor directly connected to an input end of a transmission; determining, when the engine clutch is in an opened state, whether or not to engage the engine clutch in order to perform additional regenerative braking by using the first motor; and performing regenerative braking based on whether or not to engage the engine clutch.

### CROSS-REFERENCE TO RELATED APPLICATION(S)

The present application claims the benefit of and priority to Korean Patent Application No. 10-2024-0130938, filed on Sep. 26, 2024, in the Korean Intellectual Property Office, the entire contents of which are incorporated herein by reference.

### TECHNICAL FIELD

The present disclosure relates to a hybrid electric vehicle capable of more efficient regenerative braking and relates to a regenerative braking control method therefor.

### BACKGROUND

Recently, as environmental awareness has grown, the demand for eco-friendly vehicles equipped with electric motors, as a power source, is rising. Eco-friendly vehicles are also called electrified vehicles and include, as typical examples, hybrid electric vehicles (HEVs) and electric vehicles (EVs).

A hybrid electric vehicle generally refers to a vehicle that uses two types of power sources, such as an engine and an electric motor. This hybrid electric vehicle has excellent fuel efficiency and power performance and is advantageous in reducing exhaust gas emissions, compared to vehicles equipped with only internal combustion engines, so active development therefor is being conducted.

When braking, the hybrid electric vehicle (HEV) is able to brake by converting the vehicle's kinetic energy into electric energy by operating the motor as a generator, in addition to the existing hydraulic friction brake. This type of braking is called “regenerative braking”. The hybrid electric vehicle performs regenerative braking to maximize the braking amount when braking in order to increase fuel efficiency, and the maximum regenerative braking amount is determined by the maximum power of the motor and the battery state of charge (SOC). However, in general hybrid electric vehicles, even if two or more motors are equipped, control for regenerative braking is performed based on a driving motor, and utilizing the remaining motors to improve regenerative braking efficiency is not being considered.

The foregoing description in the background section is intended merely to aid in the understanding of the background of the present disclosure and is not intended to mean that the foregoing description in the background section falls within the purview of the related art already known to those having ordinary skill in the art.

### SUMMARY

The present disclosure is directed to a hybrid electric vehicle capable of more efficient regenerative braking and is related to a regenerative braking control method therefor.

In particular, the present disclosure is intended to provide a hybrid electric vehicle capable of efficient regenerative braking by using different motors and provide a regenerative braking control method therefor.

The technical object of an embodiment of the present disclosure is not limited to the technical objects mentioned above. Other technical objects not mentioned should be clearly understood by those having ordinary skill in the art to which the present disclosure pertains from the following description.

According to an embodiment of the present disclosure, a method for controlling regenerative braking of a hybrid electric vehicle may include determining, when a braking request occurs, a state of an engine clutch configured to selectively connect a first motor directly connected to an engine and a second motor directly connected to an input end of a transmission. The method may further include determining, when the engine clutch is in an opened state, whether or not to engage the engine clutch in order to perform additional regenerative braking with the first motor. The method may further include performing regenerative braking based on whether or not to engage the engine clutch.

According to an embodiment, determining whether or not to engage the engine clutch may include determining preset engine clutch engagement conditions.

According to an embodiment, the preset engine clutch engagement conditions may include a driving load condition according to whether or not energy recovery is possible and a state of charge of a battery.

According to an embodiment, the preset engine clutch engagement conditions may include an engine stall prevention condition according to engine revolutions per minute (RPM) when the engine clutch is engaged. The preset engine clutch engagement conditions may further include a regenerative braking early-termination prevention condition according to a vehicle speed.

According to an embodiment, the preset engine clutch engagement conditions may include a residual torque condition for residual torque capable of being executed by the additional regenerative braking through the first motor in a regenerative braking allowance according to the braking request. The preset engine clutch engagement conditions may further include a charging power limit condition according to a charge amount of the second motor during the additional regenerative braking and a charging power limit of a battery.

According to an embodiment, the preset engine clutch engagement conditions further include a consumption energy condition according to a predicted power of the first motor during the additional regenerative braking and an engagement consumption power for speed synchronization of the engine and the second motor.

According to an embodiment, the method may further include determining the predicted power to be a smallest value among a value obtained by subtracting the charge amount of the second motor from the charging power limit of the battery, a value obtained by multiplying a value obtained by subtracting a torque of the second motor and a friction torque of the engine from the regenerative braking allowance according to the braking request by RPM of the second motor, and a charging power limit of the first motor. The method may further include predetermining a value of the engagement consumption power by using a speed difference between the engine and the second motor as a factor.

According to an embodiment, the preset engine clutch engagement conditions may further include a consumption energy condition according to a predicted charging energy of the first motor during the additional regenerative braking and an engagement consumption energy for speed synchronization of the engine and the second motor.

According to an embodiment, the method may further include performing control, if all of the preset engine clutch engagement conditions are satisfied, to engage the engine clutch and perform regenerative braking by using both the first motor and the second motor.

According to an embodiment, performing control may include controlling a charging power of the first motor to be a value obtained by subtracting a charging power of the second motor from a charging power limit of a battery. Performing control may further include controlling a torque of the first motor to be a value obtained by subtracting a torque of the second motor and a friction torque of the engine from a regenerative braking allowance according to the braking request.

In addition, a computer-readable recording medium according to an embodiment of the present disclosure may store a program to execute the method of controlling regenerative braking of a hybrid electric vehicle described above.

In addition, according to another embodiment of the present disclosure, a hybrid electric vehicle may include: an engine; a first motor directly connected to the engine; an engine clutch having one end connected to the first motor; a second motor connected to the other end of the engine clutch and configured to be selectively connected to the first motor through the engine clutch; a transmission having an input end directly connected to the second motor; and a controller. The controller is configured to determine, when a braking request occurs, a state of an engine clutch. The controller is further configured to determine, when the engine clutch is in an opened state, whether or not to engage the engine clutch in order to perform additional regenerative braking with the first motor. The controller is further configured to perform control to perform regenerative braking based on the determining whether or not to engage the engine clutch.

According to an embodiment, the controller may be further configured to determine preset engine clutch engagement conditions in order to determine whether or not to engage the engine clutch.

According to an embodiment, the engine clutch engagement conditions may include a driving load condition according to whether or not energy recovery is possible and a state of charge of a battery.

According to an embodiment, the engine clutch engagement conditions may include an engine stall prevention condition according to engine RPM when the engine clutch is engaged. The engine clutch engagement conditions may further include a regenerative braking early-termination prevention condition according to a vehicle speed.

According to an embodiment, the engine clutch engagement conditions may include a residual torque condition for residual torque capable of being executed by the additional regenerative braking through the first motor in a regenerative braking allowance according to the braking request. The engine clutch engagement conditions may further include a charging power limit condition according to a charge amount of the second motor during the additional regenerative braking and a charging power limit of a battery.

According to an embodiment, the engine clutch engagement conditions may further include a consumption energy condition according to a predicted power of the first motor during the additional regenerative braking and an engagement consumption power for speed synchronization of the engine and the second motor.

According to an embodiment, the controller may be further configured to determine the predicted power to be a smallest value among a value obtained by subtracting the charge amount of the second motor from the charging power limit of the battery, a value obtained by multiplying a value obtained by subtracting a torque of the second motor and a friction torque of the engine from the regenerative braking allowance according to the braking request by RPM of the second motor, and a charging power limit of the first motor. The controller may be further configured to predetermine a value of the engagement consumption power by using a speed difference between the engine and the second motor as a factor.

According to an embodiment, the engine clutch engagement conditions may further include a consumption energy condition according to a predicted charging energy of the first motor during the additional regenerative braking and an engagement consumption energy for speed synchronization of the engine and the second motor.

According to an embodiment, the controller may be configured to perform control, if all of the preset engine clutch engagement conditions are satisfied, to engage the engine clutch and perform regenerative braking by using both the first motor and the second motor.

According to an embodiment, the controller may be further configured to control a charging power of the first motor to be a value obtained by subtracting a charging power of the second motor from a charging power limit of a battery. The controller may be further configured to control a torque of the first motor to be a value obtained by subtracting a torque of the second motor and a friction torque of the engine from a regenerative braking allowance according to the braking request.

According to various embodiments of the present disclosure described above, more efficient regenerative braking is possible in the hybrid electric vehicle.

In particular, the present disclosure determines, when the engine clutch is in an opened state at the time of braking request, whether or not to perform regenerative braking with the first motor by actively engaging the engine clutch through determination about various conditions. Thus, additional energy recovery through the first motor is enabled based on circumstances.

Advantageous effects obtainable from the present disclosure may not be limited to the above-mentioned effects. Other effects, which are not mentioned, may be clearly understood from the following descriptions by those having ordinary skill in the art to which the present disclosure pertains.

### BRIEF DESCRIPTION OF THE DRAWINGS

The above and other aspects, features, and advantages of the present disclosure should be more apparent from the following detailed description taken in conjunction with the accompanying drawings, in which:

FIG. 1 illustrates an example of a powertrain configuration of a hybrid electric vehicle according to an embodiment of the present disclosure.

FIG. 2 illustrates an example of a control system configuration of a hybrid electric vehicle according to an embodiment of the present disclosure.

FIG. 3 illustrates an example in which a braking amount is distributed when a braking request is made in a hybrid electric vehicle according to an embodiment of the present disclosure.

FIG. 4 is a flowchart illustrating an example of performing regenerative braking in a hybrid electric vehicle according to an embodiment of the present disclosure.

FIG. 5 is a flowchart illustrating an example of performing regenerative braking in a hybrid electric vehicle according to another embodiment of the present disclosure.

It should be understood that the appended drawings are not necessarily to scale and present a somewhat simplified representation of various features illustrating the basic principles of the present disclosure. The predetermined design features of the present disclosure including, for example, specific dimensions, orientations, locations, and shapes may be determined in part by the particularly intended application and use environment.

In the figures, same reference numbers refer to the same or equivalent portions of the present disclosure throughout the figures.

### DETAILED DESCRIPTION

Hereinafter, embodiments set forth herein are described in detail with reference to the accompanying drawings, and the same or similar elements are given the same and similar reference numerals throughout the figures, so duplicate descriptions thereof have been omitted. The terms “module” and “unit” used for the elements in the following descriptions are given or interchangeably used for the ease of writing the present disclosure and do not have distinct meanings or roles by themselves. Furthermore, in describing the embodiments disclosed in the present disclosure, when the detailed description of the relevant known technology is determined to unnecessarily obscure the gist of the present disclosure, the detailed description may be omitted. In addition, it should be appreciated that the accompanying drawings are provided only for the sake of easy understanding of the embodiments set forth herein. The technical idea of the present disclosure is not limited to the accompanying drawings and includes all modifications, equivalents, or alternatives falling within the spirit and scope of the present disclosure.

Terms including ordinal numbers such as “a first” and “a second” may be used to describe various elements, but the elements are not limited to the terms. The above terms are used merely for the purpose of distinguishing one element from other elements.

In the case where an element is referred to as being “connected” or “coupled” to any other elements, it should be understood that not only the element may be directly connected or coupled to the other elements, but also another element may exist therebetween. In contrast, in the case where an element is referred to as being “directly connected” or “directly coupled” to any other element, it should be understood that no other element exists therebetween.

A singular expression may include a plural expression unless they are differently defined in a context.

As used herein, the terms such as “include” and “have” are intended to specify the existence of mentioned features, numbers, steps, operations, elements, components, or combinations thereof. The terms should be construed as not precluding the possible existence or addition of one or more other features, numbers, steps, operations, elements, components, or combinations thereof.

In addition, a unit or a control unit included in, for example, a motor control unit (MCU) and a hybrid control unit (HCU), is merely a term widely used for naming a controller configured to control a specific function of a vehicle. However the unit or the control unit does not mean a generic function unit. For example, in order to control a function that a control unit is responsible for, each control unit may include a communication device configured to communicate with a sensor or another control unit, a memory configured to store an operation system, a logic command, or input/output information, and at least one processor configured to perform determination, calculation, decision or the like, which are required for responsible function controlling. When a controller, module, component, device, element, part, unit, or the like of the present disclosure is described as having a purpose or performing an operation, function, or the like, the controller, module, component, device, element, part, unit, or the like should be considered herein as being “configured to” meet that purpose or to perform that operation or function. Each controller, module, component, device, element, part, unit, and the like may separately embody or be included with a processor and a memory, such as a non-transitory computer readable media, as part of the apparatus.

Prior to description of a regenerative braking control method according to the embodiments of the present disclosure, a structure and control system of a hybrid electric vehicle applicable to the embodiments is first explained.

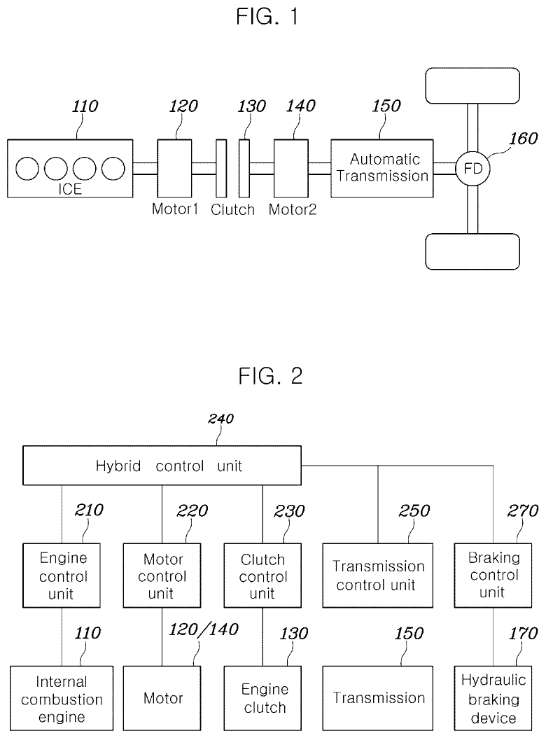

FIG. 1 illustrates an example of a powertrain configuration of a hybrid electric vehicle according to an embodiment of the present disclosure.

FIG. 1 illustrates a power train of a hybrid electric vehicle that adopts a parallel-type hybrid system including two motors 120 and 140 and an engine clutch 130, which are installed between an engine (ICE: Internal Combustion Engine) 110 and a transmission 150. This parallel-type hybrid system is also called a “Transmission Mounted Electric Drive (TMED) hybrid system” because the motor 140 is constantly connected to the input end of the transmission 150.

Here, among the two motors 120 and 140, a first motor 120 is disposed between the engine 110 and one end of the engine clutch 130. An engine shaft of the engine 110 and a first motor shaft of the first motor 120 are directly connected to each other and may rotate together at all times.

One end of a second motor shaft of a second motor 140 may be connected to the other end of the engine clutch 130, and the other end of the second motor shaft may be connected to the input end of the transmission 150.

The second motor 140 may have a greater output than the first motor 120 and thus may play the role of a driving motor. In addition, the first motor 120 may function as a starter motor that cranks the engine 110 when starting the engine 110, may recover rotational energy of the engine 110 through power generation when the engine is turned off, and may perform power generation with the power of the engine 110 while the engine 110 is running.

In a hybrid electric vehicle equipped with the powertrain shown in FIG. 1, when the driver steps on the accelerator pedal after starting (e.g., hybrid electric vehicle (HEV) Ready) the vehicle, the second motor 140 is preferentially driven using the power of a battery in the state where the engine clutch 130 is opened. Accordingly, the power of the second motor 140 is transferred through the transmission 150 and a final drive (FD) 160, and thus wheels are rotated (i.e., electric vehicle (EV) mode). If a greater driving force is required as the vehicle gradually accelerates, the first motor 120 may operate to crank the engine 110.

If a difference in rotation speed between the engine 110 and the second motor 140 falls within a predetermined range after the engine 110 is started, the engine clutch 130 is engaged, so that the engine 110 and the second motor 140 rotate together (i.e., transition from EV mode to HEV mode). Accordingly, the output of the second motor 140 decreases and the output of the engine 110 increases through a torque blending process, and thus the torque required by a driver is satisfied. In the HEV mode, the engine 110 may satisfy most of the required torque, and the difference between the engine torque and the required torque may be compensated for by at least one of the first motor 120 or the second motor 140. For example, in consideration of the efficiency of the engine 110, when the engine 110 outputs a torque higher than the required torque, the first motor 120 or the second motor 140 may generate power equivalent to the surplus of the engine torque, and when the engine torque is less than the required torque, at least one of the first motor 120 or the second motor 140 may output a torque corresponding to deficiency.

If a preset engine-off condition is satisfied, such as when the vehicle is decelerating, the engine clutch 130 is opened and the engine 110 is stopped (i.e., transition from HEV mode to EV mode). During deceleration, the battery is charged through the second motor 140 using the driving force of the wheels, which is called “braking energy recovery” or “regenerative braking”. If the engine clutch 130 is in the engaged state during deceleration, the battery may be further charged through regenerative braking of the first motor 120.

The transmission 150 may generally be an automatic transmission or a multi-plate clutch transmission such as a dual clutch transmission (DCT).

FIG. 2 illustrates an example of a control system configuration of a hybrid electric vehicle according to an embodiment of the present disclosure.

Referring to FIG. 2, in a hybrid electric vehicle to which the embodiments of the present disclosure are applicable, the internal combustion engine 110 may be controlled by an engine control unit 210, torque of the first motor 120 and the second motor 140 may be controlled by a motor control unit (MCU) 220, and the engine clutch 130 may be controlled by a clutch control unit 230. Here, the engine control unit 210 is also called an “engine management system (EMS). In addition, the transmission 150 is controlled by a transmission control unit 250, and a hydraulic braking device 170 is controlled by a braking controller unit 270.

The motor control unit 220 may control a gate drive unit with a control signal in the form of pulse width modulation (PWM), based on the motor angle, phase voltage, phase current, and required torque of each motor 120 or 140, and the gate drive unit may control an inverter that drives each motor 120 or 140 according thereto. The motor control unit 220 may be provided for each motor 120 or 140.

The respective controller units are connected to a hybrid control unit (HCU) 240, as a higher controller, which controls the entire powertrain including a mode switching process. Thus, the hybrid control unit 240 is provided with information necessary for controlling the engine clutch when the driving mode and changing gear are switched, and/or the hybrid control unit 240 is provided with information necessary for engine stop control under the control of the hybrid control unit 240. An operation is performed according to the control signal.

For example, the hybrid control unit 240 determines whether to perform switching between EV and HEV modes or between charge depleting (CD) and charge sustaining (CS) modes (in the case of plug-in hybrid electric vehicle (PHEV)) based on the driving status of the vehicle. To this end, the hybrid control unit determines the open timing of the engine clutch 130 and performs hydraulic control when the engine clutch is opened. In addition, the hybrid control unit 240 may determine the status (lock-up, slip, open, etc.) of the engine clutch 130 and may control the fuel injection stop timing of the engine 110. In addition, the hybrid control unit may transmit, to the motor control unit 220, a torque command to control the torque of the first motor 120 for engine stop control and thus may control engine rotation energy recovery. In addition, the hybrid control unit 240 may determine the states of the respective driving sources 110, 120, and 140 to satisfy the required torque, may determine required driving forces to be shared by the respective driving sources 110, 120, and 140 according thereto, and then may transmit a torque command to the control units 210 and 220 that control the respective driving sources.

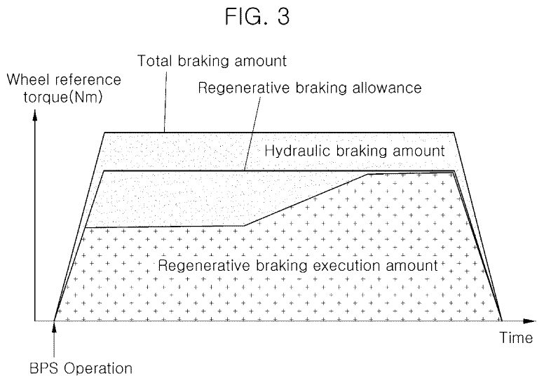

The braking control unit 270 may determine the total braking amount corresponding to a brake pedal position sensor (BPS) value when a braking request is received, for example, when the driver operates the brake pedal so that a brake pedal position sensor (BPS) is turned on. In addition, the braking control unit 270 may determine a regenerative braking allowance recoverable through regenerative braking within the total braking amount and may transmit the same to the hybrid control unit 240. Accordingly, the hybrid control unit 240 may control the motor control unit 220 according to the allowance to execute regenerative braking, may determine the execution amount, and may transmit the same to the braking control unit 270. The braking control unit 270 may perform control such that the remaining braking amount, excluding the regenerative braking execution amount from the total braking amount, is executed through the hydraulic braking device 170. More specific distribution of the braking amount is described below with reference to FIG. 3.

It should be apparent to those having ordinary skill in the art that the above-described connection relationship between control units and the functions/divisions of the control units are only examples and are not limited to their names. For example, the hybrid control unit 240 may be implemented so that its functions are provided by one of the remaining control units, excluding the hybrid control unit 240, or the corresponding functions may be provided by two or more of the remaining control units to be distributed.

It should be apparent to those having ordinary skill in the art that the above-described configurations in FIGS. 1 and 2 are only examples of hybrid electric vehicles and that the hybrid electric vehicle applicable to the embodiments are not limited thereto.

Next, an example in which the braking amount is distributed when a braking request is made is described with reference to FIG. 3.

Referring to FIG. 3, the horizontal axis of a graph shown represents time, and the vertical axis represents wheel reference torque, respectively.

As the driver operates the brake pedal (BPS ON), the braking control unit 270 may determine the total braking amount and a regenerative braking allowance within that range. The hybrid control unit 240 may control the motor control unit 220 within the regenerative braking allowance to perform regenerative braking through at least one of the currently available motor 120 or 140. The hybrid control unit 240 may transmit information about the regenerative braking execution amount measured by the motor control unit 220 to the braking control unit 270. The braking control unit 270 may perform control such that the torque, excluding the regenerative braking execution amount from the total braking amount, is executed through the hydraulic brake (i.e., the hydraulic braking amount). If a predetermined condition (e.g., reaching a preset regenerative braking termination speed or less) is satisfied, the regenerative braking is terminated, and the vehicle may be completely stopped through the hydraulic braking.

Here, the regenerative braking execution amount indicates the sum of the execution amount through the first motor 120 and the execution amount through the second motor 140. Assuming the powertrain of the hybrid electric vehicle described above with reference to FIG. 1, the second motor 140 is constantly connected to the input end of the transmission 150 so as to be physically connected to the wheel. Therefore, unless the input end and the output end of the transmission 150 are disconnected, it is able to be involved in regenerative braking. However, the first motor 120 is physically connected to the wheel (driving shaft) only when the engine clutch 130 is engaged, so it has a limitation in contributing to the regenerative braking. In other words, when the engine clutch 130 is engaged, the first motor 120 and the second motor 140 may respectively perform regenerative braking within the regenerative braking allowance and thus may execute a regenerative braking amount exceeding the charging limit torque of the second motor 140. However, when the engine clutch 130 is opened, only the second motor 140 may perform regenerative braking. As a result, when the engine clutch 130 is in the opened state, even if the regenerative braking allowance is sufficiently large, the actually executable regenerative braking amount is limited by the charging limit torque of the second motor 140.

Therefore, an embodiment of the present disclosure proposes to determine whether or not to engage the engine clutch 130, when a braking request is received, based on various conditions, in order to cause the first motor 120 to contribute to regenerative braking. When the engine clutch 130 is engaged, an additional regenerative braking amount may be executed through the first motor 120 in addition to the regenerative braking amount through the second motor 140. Thus, more energy during braking is recovered. In addition, because the engine clutch 130 is engaged, quick starting may be secured when a re-acceleration request is received during braking.

However, if the engine clutch 130 is already opened when the braking request occurs, the involvement of the first motor 120 in the regenerative braking through engagement of the engine clutch 130 may not always contribute to improving efficiency. More specifically, in the opened state of the engine clutch 130, the engagement of the engine clutch 130 may be considered as follows, based on the starting state (ON/OFF) of the engine 110.

### 1) When Driving in EV Mode

If the vehicle is driving in an EV mode, the engine 110 is turned off, so it brings about energy loss for engine cranking and fuel injection/ignition by the driving of the first motor 120, and speed control of the engine 110 to satisfy an engine clutch 130 engagement condition, before engaging the engine clutch 130.

### 2) Idle Control Situation

Because the engine 110 is started, cranking is not necessary, but energy loss occurs for controlling the speed of the engine 110 for engaging the engine clutch 130.

As a result, the engagement of the engine clutch 130 causes energy loss in both the case where the vehicle is driving in the EV mode and the case where the engine 110 is controlled in the idle state when a braking request occurs. Therefore, the engine clutch 130 must be engaged to improve the regenerative braking efficiency only when energy equal to or greater than the loss is expected to be recovered through the first motor 120.

Conditions considered in determining whether or not to engage the engine clutch 130 according to an embodiment may include an energy-recoverable condition, an engine stall prevention condition, a regenerative braking early-termination prevention condition, a residual regenerative torque condition, a battery charging power condition, and the like. Hereinafter, for convenience, the respective conditions considered in determining whether or not the engine clutch 130 is engaged are referred to as “engine clutch engagement conditions”. The engine clutch engagement conditions are described in detail as follows.

First, the energy-recoverable condition may include a driving load condition and a state of charge (SOC) condition.

The driving load condition may be satisfied if the current driving load (LdLvl) is equal to or less than a preset threshold driving load (LdLvlTh) (i.e., LdLvl≤LdLvlTh). Here, the current driving load may be determined by the hybrid control unit 240 by summating at least one of a slope load, an air resistance load, a rolling resistance load, or a towing load. The method for determining each load is widely known in the art, so a detailed description thereof has been omitted from the present disclosure. In addition, the threshold driving load may be a value determined through a test for each type of hybrid electric vehicle.

The SOC condition may be satisfied if the current battery SOC is equal to or less than a preset threshold SOC (SOCTh) (i.e., SOC≤SOCTh). This is due to the fact that sufficient regenerative braking is possible only when the battery is in the sufficient SOC. The threshold SOC (SOCTh) may be a value determined by considering the energy normally recovered through regenerative braking using both the first motor 120 and the second motor 140 through a test, but this is an example and is not necessarily limited thereto.

The engine stall prevention condition is intended to prevent, when the speed between both ends of the engine clutch 130 is synchronized to engage the engine clutch 130, the occurrence of engine stall that may occur when the speed of the engine 110 is synchronized to the speed of the second motor 140 despite the speed of the second motor 140 being too low. This engine stall prevention condition may include a second motor speed condition and a gear condition.

The second motor speed condition may be satisfied if the speed (Np2) of the second motor 140 is equal to or greater than a preset threshold motor speed (Np2Th) (i.e., Np2≥Np2Th). The threshold motor speed (Np2Th) may be determined as a value obtained by adding a predetermined margin to the revolutions per minute (RPM) at which the engine 110 stalls, but this is an example and is not necessarily limited thereto.

In addition, the gear condition may be satisfied if the current gear (CurGr) is equal to or greater than a preset threshold gear (GrTh) (i.e., CurGr≥GrTh). This is due to the fact that, when the current gear (CurGr) is equal to or greater than the threshold gear (GrTh), if the vehicle speed decreases due to braking, a downshift will occur according to the gear shift pattern, and thus the input speed of the transmission 150 will also increase. Thus, the engine stall is prevented. In addition, because shifting from the second gear to the first gear is usually conducted just before the vehicle is stopped, if the engine clutch 130 is engaged to perform regenerative braking using the first motor 120 at a low gear such as the second gear, the engine stall due to a decrease in RPM after the engagement or the sense of incongruity due to the forced release of the engine clutch according thereto may be prevented by limiting the gear stage. Therefore, the threshold gear (GrTh) may be the third gear or higher, but this is an example and is not necessarily limited thereto, and it may be determined through testing depending on the vehicle type and transmission specifications.

Next, the regenerative braking early-termination prevention condition may be satisfied if the current vehicle speed (VehSpd) is equal to or greater than a preset threshold vehicle speed (SpdTh) (i.e., VehSpd≥SpdTh). This is due to the fact that, if the current vehicle speed is close to a preset regenerative braking termination speed, regenerative braking will be terminated early after braking starts, and thus the recoverable energy is limited. The threshold speed (SpdTh) may be determined through testing in consideration of the regenerative braking termination speed.

The residual regenerative torque condition may be satisfied if a value obtained by subtracting a charging limit torque (Tp2ca) of the second motor 140 from a regenerative braking-allowable torque (i.e., regenerative braking allowance) (Tca) is greater than or equal to a preset threshold torque (Tth) (i.e., Tca Tp2ca≥Tth). This is due to the fact that, even if the second motor 140 performs regenerative braking at the maximum regenerative amount possible in the current situation, the first motor 110 is able to output the regenerative torque only when there is some amount of regenerative braking allowance remaining. The threshold torque (Tth) may also be a value determined through testing.

The battery charging power condition may be satisfied if a value obtained by subtracting a charging power limit (Pp2cl) of the second motor 140 from a battery charging power limit (Pbcl), which is the maximum charging power value acceptable in the battery, is greater than or equal to a preset threshold power (Pth) (i.e., Pbcl-Pp2cl≥Pth). This is due to the fact that, even if the second motor 140 performs regenerative braking at the maximum charging power possible in the current situation, the first motor 110 is able to further perform regenerative braking only when there is some amount of available charging power remaining in the battery. The threshold torque (Tth) may also be a value determined through testing. The threshold power (Pth) may also be a value determined through testing.

If all of the conditions described above are satisfied, the hybrid control unit 240 may determine to engage the engine clutch 130 to perform additional regenerative braking with the first motor 120. At this time, the hybrid control unit 240 may perform the following determination to determine the operating point of the first motor 120 after engagement of the engine clutch 130.

First, the charging power (Pp1) of the first motor 120 may be determined as a value obtained by subtracting a charging power (Pp2) of the second motor 140 from the charging power limit (Pbcl) of the battery (i.e., Pp1=Pbcl−Pp2).

In addition, a charging torque (Tp1) of the first motor 120 may be determined as a value obtained by subtracting the regenerative braking amount (Tp2) of the second motor 140 and a friction torque (Tfr) of the engine 110 from the regenerative braking allowance (Tca) (i.e., Tp1=Tca−(Tp2+Tfr)).

However, because the final charging torque of the first motor 120 may be limited by the charging power (Pp1), it may be a smaller value among the torque corresponding to the charging power (Pp1) and the RPM and the charging torque (Tp1) determined from the regenerative braking allowance (Tca).

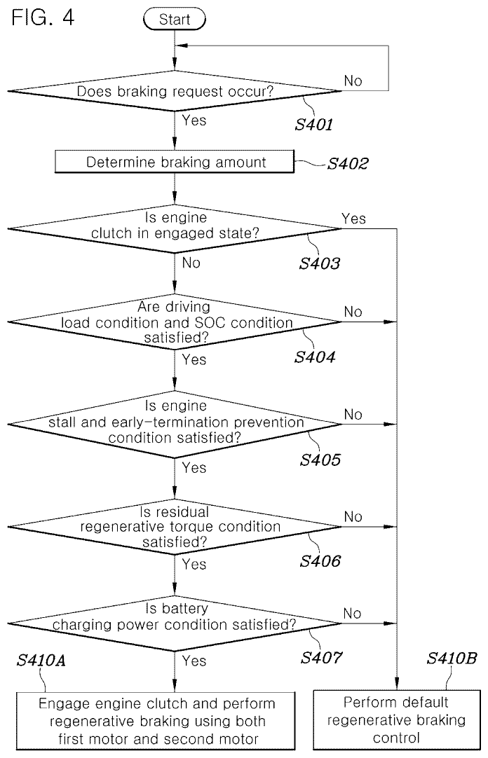

The regenerative braking control process according to the embodiment described above may be represented as a flowchart as shown in FIG. 4.

FIG. 4 is a flowchart illustrating an example of performing regenerative braking in a hybrid electric vehicle according to an embodiment of the present disclosure.

Referring to FIG. 4, when there is a braking request (“Yes” in S401), the braking control unit 270 may determine a braking amount (S402). Here, the braking request may indicate “BPS On” by operating the brake pedal by the driver or may indicate a situation in which a braking request occurs in a driving assistance function (e.g., Advanced Driver Assistance System (ADAS)) or an autonomous driving function. In addition, the braking amount determined by the braking control unit 270 may include a total braking amount and a regenerative braking allowance within the total braking amount. Information about the regenerative braking allowance may be transmitted to the hybrid control unit 240.

If the engine clutch 130 is in an engaged state at the time at which the braking request occurs (“Yes” in S403), the hybrid control unit 240 may perform default regenerative braking control (S410B). Here, the default regenerative braking control indicates a kind of regenerative braking control to perform regenerative braking in the engaged state of the engine clutch 130 or to release the engine clutch 130 and perform regenerative braking, without control to actively engage the engine clutch 130, which is in a released (i.e., open) state, during regenerative braking. At this time, a condition for maintaining the engagement of the engine clutch 130 may be satisfied if a value obtained by adding a predetermined margin to the charging limit torque (Tp2ca) of the second motor 140 is smaller than the smaller value of the torque according to the charging power limit of the battery and the regenerative braking allowance (allowable torque) (Tca) of the braking control unit 270. If the condition for maintaining the engagement of the engine clutch 130 is satisfied, the first motor 120 is involved in the regenerative braking together with the second motor 140, and if the condition is not satisfied, the engine clutch 130 may be released and regenerative braking may be performed using only the second motor 140. In the case where the default regenerative braking control is performed in the state where the engine clutch 130 is already released, regenerative braking may be performed using only the second motor 140.

If the engine clutch 130 is in a released state at the time at which the braking request occurs (“No” in S403), the hybrid control unit 240 may determine whether or not preset conditions, i.e., the engine clutch engagement conditions, are satisfied in order to determine whether or not to engage the engine clutch to further use the first motor 120 for regenerative braking (S404 to S407).

As described above, the engine clutch engagement conditions may include an energy-recoverable condition (i.e., driving load condition and SOC condition, S404), an engine stall prevention and regenerative braking early-termination condition (i.e., engine stall prevention condition and early-termination prevention condition, S405), a residual regenerative torque condition (S406), and a battery charging power condition (S407). Specific criteria for determining whether the respective conditions are satisfied have been described above, so redundant descriptions thereof have been omitted.

If all conditions are satisfied, the hybrid control unit 240 may engage the engine clutch 130 and may perform regenerative braking using both the first motor 120 and the second motor 140 (S410A). At this time, the operating point of the first motor 120 may be determined in consideration of the charging power of the battery and the second motor 140, the regenerative braking allowance, the regenerative braking amount of the second motor 140, the friction torque of the engine 110, and the like.

On the other hand, if at least one of the conditions is not satisfied, the hybrid control unit 240 may perform default regenerative braking (S410B).

In FIG. 4, although the respective engine clutch engagement conditions (S404 to S407) are sequentially determined, this is exemplary and are not necessarily limited thereto. For example, the determination order of the respective engine clutch engagement conditions may be configured differently from that in FIG. 4, and at least some conditions may be determined simultaneously in parallel.

Meanwhile, the engine clutch engagement conditions according to an embodiment of the present disclosure are configured to enable energy recovery through regenerative braking via the first motor 120. However, even if energy recovery itself is possible through regenerative braking via the first motor 120, energy is consumed for engine speed synchronization and the like until the engine clutch 130 is engaged.

Therefore, another embodiment of the present disclosure proposes a method of adding an energy condition consumed for engaging the engine clutch 130 (hereinafter, referred to as a “consumption energy condition” for convenience) to the engine clutch engagement conditions.

When the energy recovered by the additional regenerative braking through the first motor 120 is equal to or greater than the energy consumed in the speed synchronization process of the engine 110 and the second motor 140, the engagement of the engine clutch 130 may be meaningful in terms of efficiency. Therefore, the energy consumption condition may be satisfied if the predicted charging energy expected to be generated by the first motor 120 during the additional regenerative braking is equal to or greater than the energy consumed in the speed synchronization. This energy consumption condition may also be interpreted from the power perspective.

Specifically, the energy consumption condition, which improves the overall regenerative braking efficiency by engaging the engine clutch 130 and then performing the additional regenerative braking using the first motor 120, may be satisfied if the charging power of the first motor is equal to or greater than the power consumed for engaging the engine clutch 130.

In order to determine whether or not this consumption energy condition is satisfied, it is necessary to determine the charging power (i.e., expected charging power) expected to charge the battery by the first motor 120 performing regenerative braking when assuming that the engine clutch 130 is engaged.

The expected charging power of the first motor 120 may be determined as the smallest value among i) the difference between the available charging power of the battery and the charging power of the second motor 120 (Pbcl−Pp2), ii) the charging power based on the chargeable torque of the first motor 120 by the regenerative braking allowance, and iii) the charging power limit (Pp1cl) due to the temperature of the first motor 120.

Here, the difference (Pbcl−Pp2) between the available charging power of the battery and the charging power of the second motor 120 is considered because the combined charging power of the first motor 120 and the second motor 140 cannot exceed the charging power limit of the battery.

In addition, ii) the charging power based on the chargeable torque of the first motor 120 by the regenerative braking allowance may be a power value obtained by multiplying the value (Tca−(Tp2+Tfr)) obtained by subtracting the regenerative braking torque (Tp2) of the second motor and the friction torque (Tfr) of the engine from the regenerative braking allowance (Tca) transmitted from the braking control unit 270 by the RPM (Np2) of the second motor (i.e., ((Tca−(Tp2+Tfr))×Np2)).

In summary, the expected charging power (Pp1prd) of the first motor 120 may be obtained as follows.

Pp1prd=Min{(Pbcl−Pp2), ((Tca−(Tp2+Tfr))×Np2), Pp1cl}

Meanwhile, power indicates the amount of work per unit time, which may be expressed as the amount of energy transferred per hour (i.e., P=dE/dt). The energy consumed for controlling the speed of the engine (hereinafter, referred to as “speed control energy” for convenience) is a loss energy consumed to synchronize the speed of the engine 110 with the speed of the second motor 140, and its level may vary based on the speed difference between the two power sources. The magnitude of the speed control energy may be pre-determined by testing or analytical methods according to the speed difference level.

For example, if the loss energy value in a specific section is Eloss, if the expected charging power of the first motor 120 is Pp1prd, and if the reference time for which the first motor 120 is expected to continue regenerative braking after the engagement of the engine clutch 130 is Tthr, the expected energy recovery amount (Eprd) may be defined by the following relationship, assuming that the charging power of the first motor 120 is constant.

The expected energy recovery (Eprd) is the product of the expected charging power (Pp1prd) of the first motor and the reference time (Tthr), and its value must be greater than or equal to the loss energy value (Eloss). In summary, the equation “Pp1prd×Tthr≥Eloss” is established, and when both sides of this equation are divided by the reference time Tthr, it becomes “Pp1prd≥Eloss/Tthr”, so both sides may be converted into power units. Here, the loss energy (Eloss) is a function of the speed difference between the second motor 140 and the engine 110. If it is assumed to have a constant value for the same speed difference, and if the reference time (Tthr) is also pre-determined to be a constant through tests, “Eloss/Tthr” may be regarded as a function of the difference between the speed (Np2) of the second motor 140 and the speed (Neng) of the engine 110 (i.e., Eloss/Tthr=fcn[Np2−Neng]), which as a power unit.

The function of the speed difference may be replaced by the engagement consumption power (Pth), which is a power calibration value that has the speed difference as a factor. Ultimately, the consumption energy condition may be defined as follows.

Pp1prd≥Pth [x: Np2−Neng]

In other words, if the expected charging power (Pp1prd) of the first motor, i.e., “Min{(Pbcl−Pp2), ((Tca−(Tp2+Tfr))×Np2), Pp1cl}”, is equal to or greater than the engagement consumption power (Pth), which is a reference power having the speed difference (Np2−Neng) as a factor, the consumption energy condition may be satisfied.

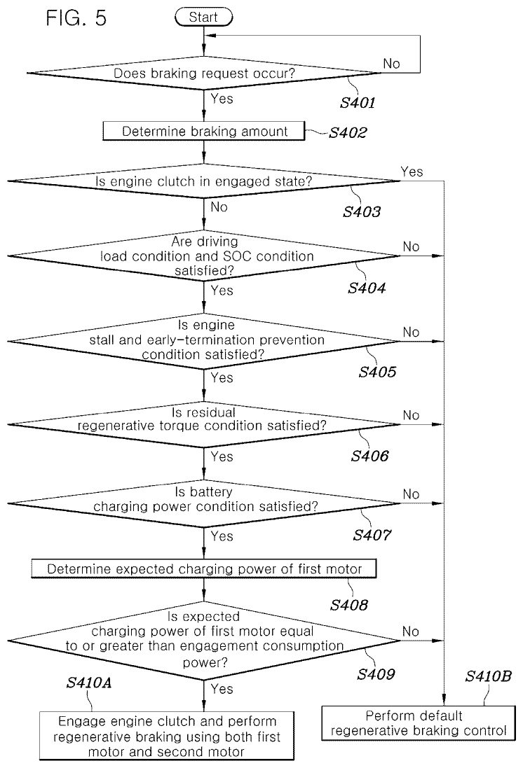

The regenerative braking control method in which the consumption energy condition is added to the engine clutch engagement conditions may be organized as a flowchart shown in FIG. 5.

FIG. 5 is a flowchart illustrating an example of performing regenerative braking in a hybrid electric vehicle according to another embodiment of the present disclosure.

Referring to FIG. 5, the processes from determining whether or not a braking request occurs (S401) to determining whether or not the battery charging power condition is satisfied are similar to those in FIG. 4, so redundant descriptions thereof have been omitted.

As described above, if there is a braking request (“Yes” in S401) and if the engine clutch 130 is in the released state (“No” in S403), the hybrid control unit 240 may determine whether or not the respective engine clutch engagement conditions are satisfied. At this time, unlike the case in FIG. 4, in the control process according to the flowchart shown in FIG. 5, the hybrid control unit 240 further determines whether or not the consumption energy condition is satisfied as the engine clutch engagement conditions (S408 and S409).

More specifically, the hybrid control unit 240 may determine whether the expected charging power (Pp1prd) of the first motor 120 is equal to or greater than an engagement consumption power (Pth) (S408) and, if the expected charging power (Pp1prd) of the first motor 120 is equal to or greater than the engagement consumption power (Pth), the hybrid control unit 240 may determine that the consumption energy condition is satisfied (“Yes” in S409).

If all of the engine clutch engagement conditions including the consumption energy condition are satisfied, the hybrid control unit 240 may engage the engine clutch 130 and perform regenerative braking using both the first motor 120 and the second motor 140. At this time, the method of obtaining the operating point of the first motor 120 is as described above (S410A).

In the above-described embodiments, when engaging the engine clutch 130 and performing regenerative braking using both the first motor 120 and the second motor 140, the hybrid control unit 240, when transmitting the regenerative braking execution amount to the braking control unit 270, may add the friction torque (Tfr) of the engine to the actual motor execution amount (Tp1+Tp2) and transmit the same thereto. In this case, the braking control unit 270 may exclude the friction torque (Tfr) of the engine when performing hydraulic braking by the difference between the total braking amount and the regenerative braking execution amount.

According to the regenerative braking control method of the embodiments described above, additional battery charge may be secured by performing additional regenerative braking of the first motor 120 through engagement of the engine clutch 130, thereby improving fuel efficiency.

In addition, when the engine clutch 130 is engaged, the friction torque of the engine 110 is able to be used as braking force, so the corresponding brake hydraulic braking amount may be reduced, thereby reducing pad and disc wear.

In addition, because the engagement of the engine clutch 130 is maintained, quick starting may be secured when a re-acceleration request is received during braking.

The present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Therefore, the above detailed description should not be construed in a limitative sense but should be considered in an illustrative sense in all aspects. The scope of the present disclosure should be determined by reasonable interpretation of the appended claims, and all changes and modifications within the equivalent scope of the present disclosure should fall within the scope of the present disclosure.

What is claimed is:

1. A method for controlling regenerative braking of a hybrid electric vehicle, the method comprising:
determining, in response that a braking request occurs, a state of an engine clutch configured to selectively connect a first motor directly connected to an engine and a second motor directly connected to an input end of a transmission;
determining, in response that the engine clutch is in an opened state, whether or not to engage the engine clutch in order to perform additional regenerative braking by using the first motor; and
performing regenerative braking based on whether or not to engage the engine clutch.

2. The method according to claim 1,
wherein determining whether or not to engage the engine clutch comprises determining whether preset engine clutch engagement conditions are satisfied or not.

3. The method according to claim 2,
wherein the preset engine clutch engagement conditions comprise a driving load condition according to whether or not energy recovery is possible and a state of charge of a battery.

4. The method according to claim 2,
wherein the preset engine clutch engagement conditions comprise:
an engine stall prevention condition according to engine revolutions per minute (RPM) when the engine clutch is engaged; and
a regenerative braking early-termination prevention condition according to a vehicle speed.

5. The method according to claim 2,
wherein the preset engine clutch engagement conditions comprise:
a residual torque condition for residual torque capable of being executed by the additional regenerative braking using the first motor in a regenerative braking allowance according to the braking request; and
a charging power limit condition according to a charge amount of the second motor during the additional regenerative braking and a charging power limit of a battery.

6. The method according to claim 5,
wherein the preset engine clutch engagement conditions further comprise a consumption energy condition according to a predicted power of the first motor during the additional regenerative braking and an engagement consumption power for speed synchronization of the engine and the second motor.

7. The method according to claim 6, further comprising:
determining the predicted power to be a smallest value among a value obtained by subtracting the charge amount of the second motor from the charging power limit of the battery, a value obtained by multiplying a value obtained by subtracting a torque of the second motor and a friction torque of the engine from the regenerative braking allowance according to the braking request by RPM of the second motor, and a charging power limit of the first motor; and
predetermining a value of the engagement consumption power by using a speed difference between the engine and the second motor as a factor.

8. The method according to claim 5,
wherein the preset engine clutch engagement conditions further comprise a consumption energy condition according to a predicted charging energy of the first motor during the additional regenerative braking and an engagement consumption energy for speed synchronization of the engine and the second motor.

9. The method according to claim 2, further comprising:
performing control, when all of the preset engine clutch engagement conditions are satisfied, to engage the engine clutch and perform regenerative braking by using both the first motor and the second motor.

10. The method according to claim 9,
wherein performing the control comprises:
controlling a charging power of the first motor to be a value obtained by subtracting a charging power of the second motor from a charging power limit of a battery; and
controlling a torque of the first motor to be a value obtained by subtracting a torque of the second motor and a friction torque of the engine from a regenerative braking allowance according to the braking request.

11. A hybrid electric vehicle comprising:
an engine;
a first motor directly connected to the engine;
an engine clutch having a first end connected to the first motor;
a second motor connected to a second end of the engine clutch and configured to be selectively connected to the first motor through the engine clutch;
a transmission having an input end directly connected to the second motor; and
a controller configured to:
determine, in response that a braking request occurs, a state of an engine clutch,
determine, in response that the engine clutch is in an opened state, whether or not to engage the engine clutch in order to perform additional regenerative braking by using the first motor, and
control regenerative braking to be performed based on whether or not to engage the engine clutch.

12. The hybrid electric vehicle according to claim 11,
wherein the controller is further configured to determine whether preset engine clutch engagement conditions for engaging the engine clutch are satisfied or not.

13. The hybrid electric vehicle according to claim 12,
wherein the preset engine clutch engagement conditions comprise a driving load condition according to whether or not energy recovery is possible and a state of charge of a battery.

14. The hybrid electric vehicle according to claim 12,
wherein the preset engine clutch engagement conditions comprise:
an engine stall prevention condition according to engine RPM when the engine clutch is engaged; and
a regenerative braking early-termination prevention condition according to a vehicle speed.

15. The hybrid electric vehicle according to claim 12,
wherein the preset engine clutch engagement conditions comprise:
a residual torque condition for residual torque capable of being executed by the additional regenerative braking using the first motor in a regenerative braking allowance according to the braking request; and
a charging power limit condition according to a charge amount of the second motor during the additional regenerative braking and a charging power limit of a battery.

16. The hybrid electric vehicle according to claim 15,
wherein the preset engine clutch engagement conditions further comprise a consumption energy condition according to a predicted power of the first motor during the additional regenerative braking and an engagement consumption power for speed synchronization of the engine and the second motor.

17. The hybrid electric vehicle according to claim 16,
wherein the controller is further configured to:
determine the predicted power to be a smallest value among a value obtained by subtracting the charge amount of the second motor from the charging power limit of the battery, a value obtained by multiplying a value obtained by subtracting a torque of the second motor and a friction torque of the engine from the regenerative braking allowance according to the braking request by RPM of the second motor, and a charging power limit of the first motor, and
predetermine a value of the engagement consumption power by using a speed difference between the engine and the second motor as a factor.

18. The hybrid electric vehicle according to claim 15,
wherein the preset engine clutch engagement conditions further comprise a consumption energy condition according to a predicted charging energy of the first motor during the additional regenerative braking and an engagement consumption energy for speed synchronization of the engine and the second motor.

19. The hybrid electric vehicle according to claim 12,
wherein the controller is further configured to perform control, when all of the preset engine clutch engagement conditions are satisfied, to engage the engine clutch and perform regenerative braking by using both the first motor and the second motor.

20. The hybrid electric vehicle according to claim 19,
wherein the controller is further configured to:
control a charging power of the first motor to be a value obtained by subtracting a charging power of the second motor from a charging power limit of a battery; and
control a torque of the first motor to be a value obtained by subtracting a torque of the second motor and a friction torque of the engine from a regenerative braking allowance according to the braking request.
